(19) United States
(12) Patent Application Publication
(10) Pub. No.: US 2026/0239316 A1
(43) Pub. Date: Aug. 13, 2026

(54) O-RAN TR ENHANCEMENT

(71) Applicant: QUALCOMM Incorporated, San Diego, CA (US)

(72) Inventors: Eran HOF, Haifa (IL); Guy WOLF, Rosh Haayin (IL); Ariel Yaakov SAGI, Haifa (IL); Lior UZIEL, Hod Hasharon (IL); Sharon LEVY, Binyamina (IL)

(21) Appl. No.: 19/048,775

(22) Filed: Feb. 7, 2025

(51) Int. Cl. H04W 72/0453; H04L 27/26; H04W 72/52

(52) U.S. Cl. CPC H04W 72/0453; H04L 27/2618; H04W 72/52

(57) ABSTRACT

Apparatus, methods, and computer program products for wireless communication are provided. An example method may include receiving, from a radio unit (RU), a request to use tone reservation (TR). The example method may further include communicating, with the RU, a confirmation to use the TR. The example method may further include communicating, with the RU, a configuration of a quantity of a set of resource blocks (RBs) associated with the TR. In some aspects, the configuration further includes a first set of locations associated with the set of RBs. In some aspects, the request to use the TR, the confirmation to use the TR, or the configuration includes an indication of waiving at least one RB from the TR.

### TECHNICAL FIELD

The present disclosure relates generally to communication systems, and more particularly, to wireless communication systems with tone reservation (TR).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a distributed unit (DU) are provided. The apparatus may include at least one memory and at least one processor coupled to the at least one memory. Based at least in part on information stored in the at least one memory, the at least one processor, individually or in any combination, is configured to (e.g., cause the DU to) receive, from a radio unit (RU), a request to use tone reservation (TR). Based at least in part on information stored in the at least one memory, the at least one processor, individually or in any combination, is configured to communicate (e.g., transmit to or receive from), with the RU, a confirmation to use the TR. Based at least in part on information stored in the at least one memory, the at least one processor, individually or in any combination, is configured to communicate (e.g., transmit to or receive from), with the RU, a configuration of a quantity of a set of resource blocks (RBs) associated with the TR.

In another aspect of the disclosure, a method, a computer-readable medium, and an apparatus at a radio unit (RU) are provided. The apparatus may include at least one memory and at least one processor coupled to the at least one memory. Based at least in part on information stored in the at least one memory, the at least one processor, individually or in any combination, is configured to transmit, to a DU, a request to use TR. Based at least in part on information stored in the at least one memory, the at least one processor, individually or in any combination, is configured to communicate (e.g., transmit to or receive from), with the DU, a confirmation to use the TR. Based at least in part on information stored in the at least one memory, the at least one processor, individually or in any combination, is configured to communicate (e.g., transmit to or receive from), with the DU, a configuration of a quantity of a set of RBs associated with the TR.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating an example for negotiation and usage of tone reservation (TR) between a radio unit (RU) and a distributed unit (DU), in accordance with various aspects of the present disclosure.

FIG. 5 is a diagram illustrating example locations of resource blocks (RBs) associated with TR, in accordance with various aspects of the present disclosure.

FIG. 6 is a diagram illustrating example communications between a RU and a DU, in accordance with various aspects of the present disclosure.

FIG. 7 is a flowchart of a method of wireless communication, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example network entity, in accordance with various aspects of the present disclosure.

FIG. 12 is a diagram illustrating an example of a hardware implementation for a network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Example aspects disclosed herein provide techniques for indicating usage of tone reservation (TR) to improve management of PAPR. Tone reservation is a technique for reducing PAPR at a transmitting device, such as a distributed unit (DU). For example, when employing tone reservation, a transmitting device may replace certain data tones of a transmission with reserved tones. The insertion of the reserved tones may cause some data to be lost, but may also reduce the amount of power associated with the transmission. Example aspects provided herein may enable a radio unit (RU) and a DU to negotiate usage of TR, such as the quantity of resource blocks (RBs) that the TR may be applicable to, the location(s) of the RBs that the TR may be applicable to, or the like. Example aspects provided herein may enable the DU to employ TR as suitable, potentially enabling better control of PAPR and improving overall efficiency of wireless communication.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

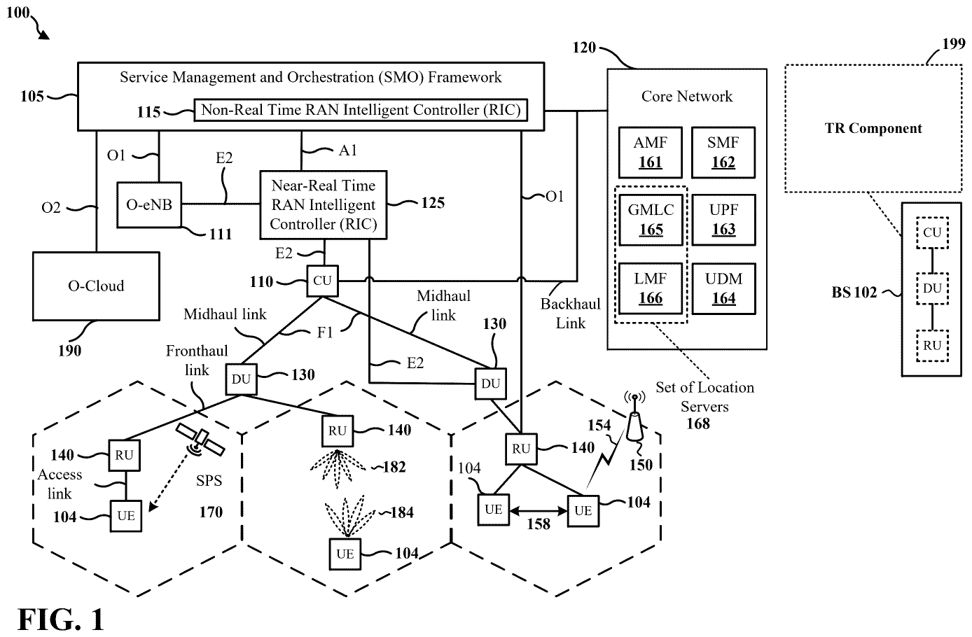

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the base station 102 (such as the DU or the RU in the base station 102) may include a TR component 199. In some aspects, the TR component 199 may be configured to communicate (e.g., transmit to or receive from), with a RU, a request to use TR. In some aspects, the TR component 199 may be further configured to transmit, to the RU, a confirmation to use the TR. In some aspects, the TR component 199 may be further configured to communicate (e.g., transmit to or receive from), with the RU, a configuration of a quantity of a set of RBs associated with the TR.

In some aspects, the TR component 199 may be configured to transmit, to a DU, a request to use TR. In some aspects, the TR component 199 may be further configured to communicate (e.g., transmit to or receive from), with the DU, a confirmation to use the TR. In some aspects, the TR component 199 may be further configured to communicate (e.g., transmit to or receive from), with the DU, a configuration of a quantity of a set of RBs associated with the TR.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

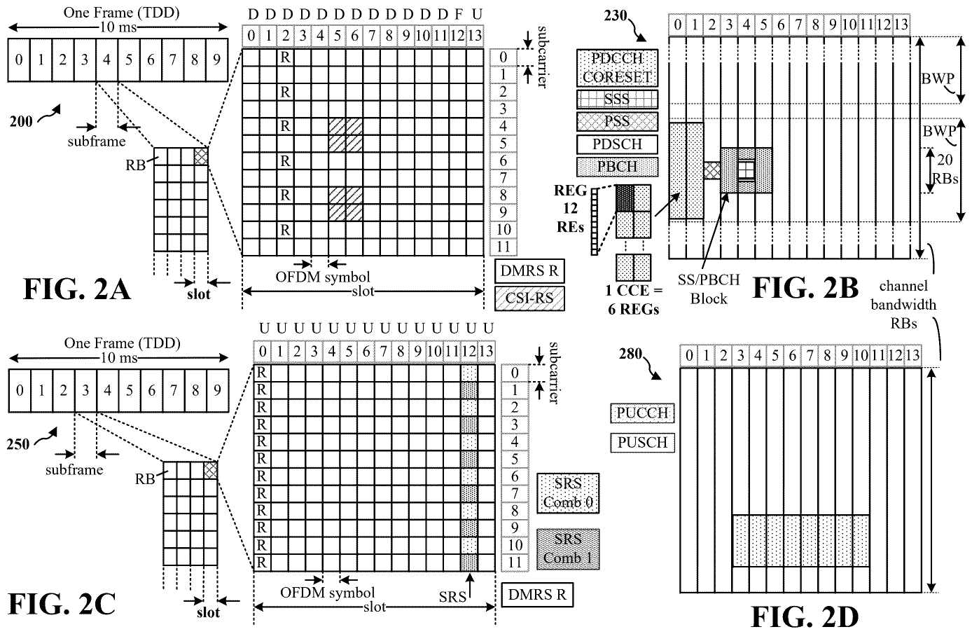

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 24^{μ}* 15 kHz, where μ is the numerology 0 to 4. As such, the numerology u=0 has a subcarrier spacing of 15 kHz and the numerology u=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

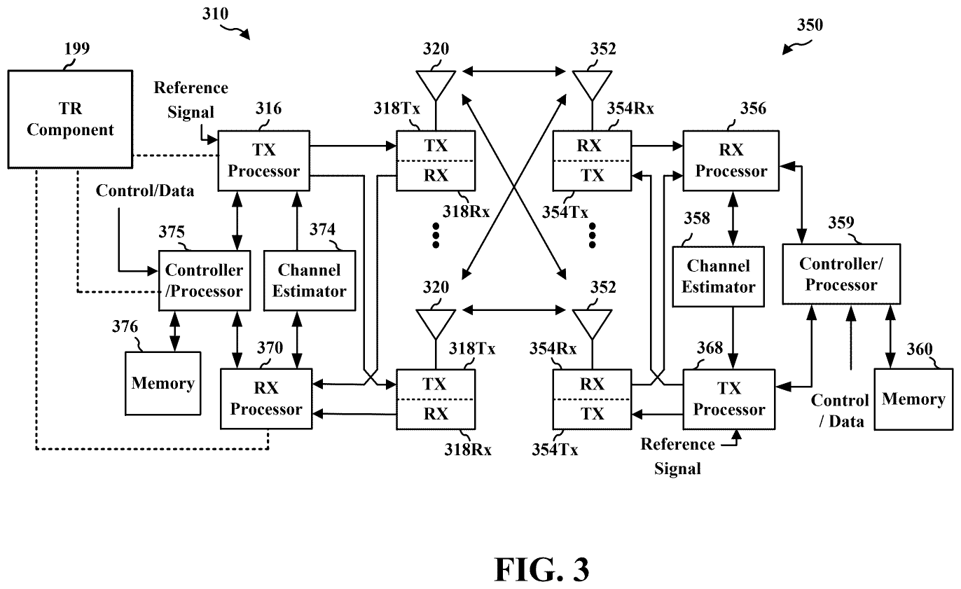

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with TR component 199 of FIG. 1.

PAPR control may be a major challenge in radio units of some wireless communication systems due to usage of OFDM signaling. PAPR controlling schemes based on adding peaking processing signals (e.g., crest factor reduction (CFR)) may be an emendable part of any radio unit solutions. These schemes may introduce distortion to the transmitted signal. As one example, signals with high PAPR may cause inefficient operation of the power amplification in power amplifiers when operated near their saturation region. As a second example, by reducing the crest factor (ratio of the peak signal power to its average power), CFR may facilitate prevention of clipping and non-linear distortion in power amplifiers, enabling them to operate more efficiently. However, the added distortion provides inherent deterioration in signal error vector magnitude (EVM), which measures the difference between the transmitted signal and the ideal (reference) signal in a modulation constellation diagram, and transmissions adjacent channel leakage ratio (ACLR) and spectral mask specifications. These properties may impose inherent maximum or minimum on achievable PAPR control levels. Other techniques may be based on major changes in signaling for certain wireless communication systems. TR is a technique that provide PAPR control without introducing distortion to the transmitted signal. TR is based on an available spectrum (available RBs for use) in the TX spectrum. As used herein, the term “TR” may refer to a technique where some RB(s) are not used for carrying data (e.g., data tones). Such RB(s) that may be not carrying data based on application of TR may be referred to as “RB(s) associated with the TR.” For example, these RBs may be used for PAPR reduction.

Compared to using CFR alone, using TR may be able to achieve better PAPR with less distortion on the transmitted signal. However, TR performance may be highly affected by the quantity of TR RBs (the quantity of RBs associated with the usage of TR) and the choice of RBs (the locations of the RBs associated with the usage of TR). Therefore, RB quantity and location of RBs that may be negotiated between a RU and a DU may be beneficial for the performance of the TR. For example, aspects presented herein provide for a negotiation between an RU and a DU, e.g., over O-RAN, that can improve TR performance.

Example aspects disclosed herein provide techniques for indicating usage of TR to improve management of PAPR. Tone reservation is a technique for reducing PAPR at a transmitting device, such as a cellular network base satiation transmitter. For example, when employing tone reservation, a transmitting device may replace certain data tones of a transmission with reserved tones. The insertion of the reserved tones may cause less RB to be available. There may be less tones available for data transmission. Example aspects provided herein may enable a RU and a DU to negotiate usage of TR, such as the quantity of RBs that the TR may be applicable to, the location(s) of the RBs that the TR may be applicable to, or the like. Example aspects provided herein may enable the DU to employ TR as suitable, potentially enabling better control of PAPR and improving overall efficiency of wireless communication. A DU may be informed with RU TR request and may operate the network accordingly. The TR may be applied based on a quantity of RBs and locations of RBs that may be indicated by the RU or determined by the DU based on its own situation. If the RU indicates a set of RBs (including the quantity and the locations of RBs) that may be associated with TR, the DU may apply the TR on a different set of RBs that may be fully overlapping with the set of RBs indicated by the RU, partially overlapping with the set of RBs indicated by the RU, or different from the set of RBs indicated by the RU. The DU may inform the RU regarding the quantity and the locations of RBs that the DU may apply the TR on. For example, the DU may inform the RU on partial choice, that is some of the RBs for TR are provided while other are chosen by the DU not in coordinated with the RU choice.

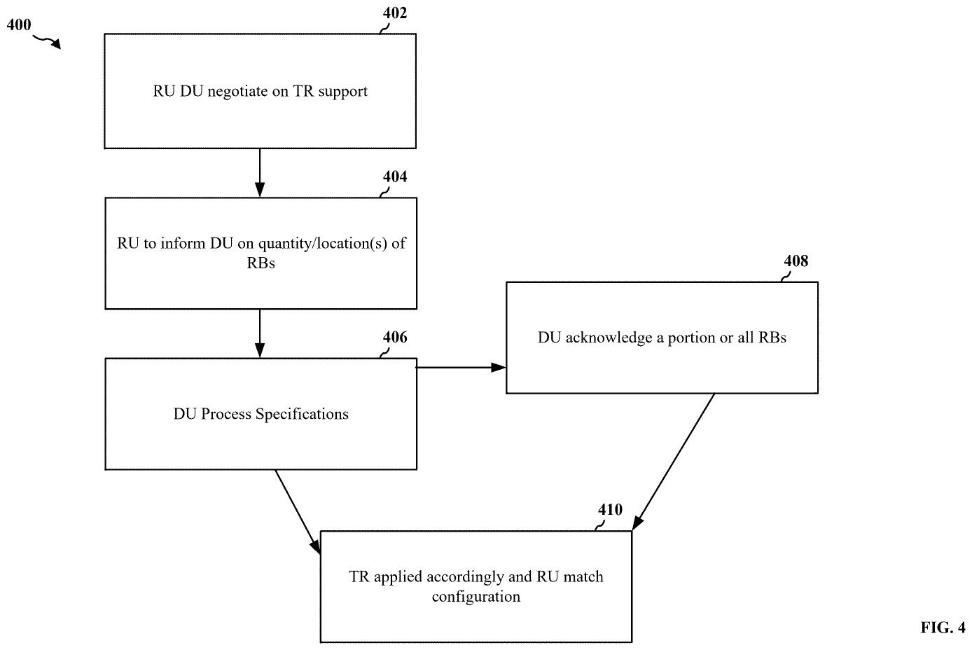

FIG. 4 is a diagram 400 illustrating an example for negotiation and usage of TR between a RU and a DU, in accordance with various aspects of the present disclosure. As an example, the RU and DU may be part of an O-RAN wireless communication system. At 402, the DU and the RU may negotiate on TR support. For example, the RU may send a request to use TR to the DU and the DU may respond with a confirmation. In some aspects, at 404, the RU may inform the DU with the quantity or location(s) of RB(s) associated with the TR. In some aspects, at 406, the DU may determine whether the indicated quantity or location(s) of RB(s) associated with the TR is suitable, or determine its own version of quantity or location(s) of RB(s) associated with the TR (regardless of whether the RU has informed the DU with the quantity or location(s) of RB(s) associated with the TR or not). In some aspects, at 410, the DU may apply (e.g., based on a RU that employs TR) the TR based on indicated quantity or location(s) of RB(s) associated with the TR or based on its own version of quantity or location(s) of RB(s) associated with the TR. In some aspects, at 408, the DU may send an acknowledgment or updated configuration indicating the quantity or location(s) of RB(s) associated with the TR to be applied first (e.g., the indicated quantity or location(s) of RB(s) associated with the TR or its own version of quantity or location(s) of RB(s) associated with the TR), then apply the TR accordingly at 410.

For example, the DU may be informed with the quantity of RBs associated with the TR, and the DU may agree or disagree with the quantity of RBs associated with the TR and negotiate accordingly with the RU. The DU may also be informed with the locations of RBs associated with the TR, and the DU may fully agree, partially or disagree with the locations of RBs associated with the TR and negotiate accordingly with the RU. In some aspects, the DU may negotiate the quantity and the location(s) of the RB(s) associated with the RU. In some aspects, the RU may not indicate at least one of the quantity of RB(s) associated with the TR or the location(s) of RB(s) associated with the TR, and the DU may determine the at least one of the quantity of RB(s) associated with the TR or the location(s) of RB(s) associated with the TR and apply the TR accordingly.

In some aspects, there may be a RB waiving mechanism. As an example, in certain scenarios after applying TR, it may be observed that some of the RBs provided for TR are not utilized by the algorithm, which may be a result of the fact the TR signals (e.g., peak correction) spectrum density is negligible on the considered RBs. To address such scenarios, the RU and DU negotiations may be support waiving certain RBs. The term “waiving at least one RB from the TR” or “waiving” may refer to indicating certain RBs to be re-used for data (information) or indicating certain RBs as unsuitable for applying TR. The waived RBs may be either replaced with alternative RBs, or the total quantity of RBs associated with the TR may change accordingly.

In some aspects, due to network and channel realizations, MCS in certain RBs may be associated with a low reliable rate and may be unsuitable for data. Therefore, system-wise, it may be better to use the less reliable RB for TR. To address such scenarios, the RU DU negotiation may support associating MCS information with the usage of the TR, the quantity of RB(s) associated with the TR, or the location(s) of RB(s) associated with the TR. For example, for different MCS, negotiation and applied configuration regarding at least one of: (1) the usage of the TR, (2) the quantity of RB(s) associated with the TR, or (3) the location(s) of RB(s) associated with the TR, may be different. In some aspects, the RU and the DU may enhance the information regarding the suggested RB(s) (e.g., RB(s) indicated by the RU) associated with the TR based on MCS information. In some aspects, the RU and the DU may agree to operate TR on the suggested RB(s). In some aspects, the DU (e.g., and the RU or without the RU's agreement) may choose a subset of RB(s) based on the suggested RB(s). In some aspects, because some RBs may allow the DU to operate with different MCS, the DU may decide to locate the TR in those RBs and locate the data in other RBs. The DU may accordingly inform the RU where TR may be applied based on the different MCS. In some aspects, out of the RB(s) suggested by the RU, the DU may choose RBs based on the MCS capability associated with the RU/DU.

In some aspects, TR negotiations between RU and DU over O-RAN may be carried on an opportunistic or mandatory (e.g., mandatory for the DU) basis. On a mandatory basis, RU demands for TR resources (quantity/location(s) of the RB(s) associated with the TR) will be applied by the DU as is. If such agreement is not possible, TR is not applied. On an opportunistic basis, DU may use the indicated TR resources (quantity/location(s) of the RB(s) associated with the TR) if possible or determined to be suitable by the DU, and if not, different quantity/location(s) of the RB associated with the TR (e.g., partial TR resources that may be a subset of the TR resources indicated by the RU) may be used by the RU to apply the TR. In some aspects, the DU may choose the RBs for the TR and the RU may apply those RBs for the TR. In some aspects, in case of partial fulfillment of the TR resources, the DU may inform or not inform the RU with a request for alternative resources. In some aspects, the negotiation process may be continued in iteration until satisfying resources are indicated by the RU (e.g., agreed upon). In some aspects, the negotiation process may end after the DU determines the quantity/location(s) of the RB associated with the TR and informs the RU of its determined quantity/location(s) of the RB associated with the TR. In some aspects, one of the quantity or the location(s) may be mandatory and the other one may be based on an opportunistic basis. For example, quantity of RBs may be mandatory and the locations may be based on an opportunistic basis. As another example, quantity of RBs may be mandatory and a subset of the location(s) may be based on an opportunistic basis. As another example, quantity of RBs may be based on an opportunistic basis and a subset of the location(s) may be mandatory.

In some aspects, TR negotiations may be fixed or dynamic. For example, in a fixed scenario, the TR resources (quantity/location(s) of the RB associated with the TR) may be agreed once per component carrier (CC) configuration and fixed accordingly. In a dynamic scenario, the TR resources (quantity/location(s) of the RB associated with the TR) may be applied and subject to further updates where the DU or the RU may update the TR resources based on: (1) channel condition (e.g., to better set the TR RBs on channel bins that are of low capacity), (2) capacity demands from network layers (e.g., which may result in reducing number of TR RBs based on higher demand, or vice versa), (3) lake of TR RBs notices by the TR performance (resulting PAPR) initiating an updated request for additional RBs or specific RBs (e.g., the TR algorithm may point to specific bins that have high potential of PAPR reduction. E.g., bins where high clipping energy is detected but those bins are currently not allocated for TR), or (4) waiving on TR RBs based on ongoing TR performance.

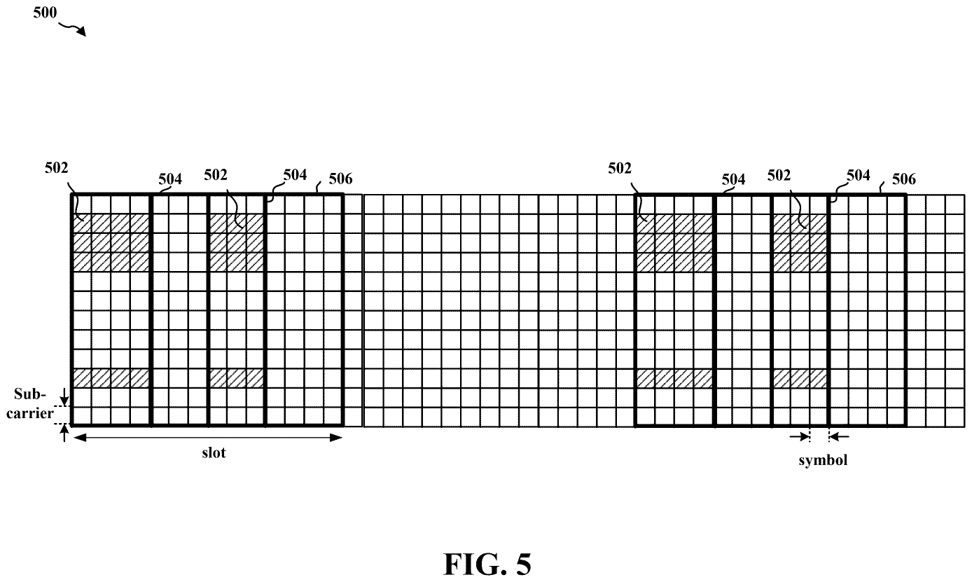

FIG. 5 is a diagram 500 illustrating example locations of RBs associated with TR, in accordance with various aspects of the present disclosure. As illustrated in FIG. 5, locations 502 of the RBs associated with TR may be indicated. In some aspects, the locations 502 of the RBs associated with TR may be indicated based on a bitmap where a first bit value (“1”) may be used for indicating an RB associated with the TR and a second bit zero (“0”) may be used for indicating RBs not associated with the TR (may be used for carrying data). In addition to the bitmap, the symbols 504 associated with the TR and the slots 506 associated with the TR may also be indicated/negotiated in some aspects. In some aspects, the RBs associated with the TR may be indicated to be associated with all future symbol/slots and there may be no indication of particular symbols/slots associated with the TR.

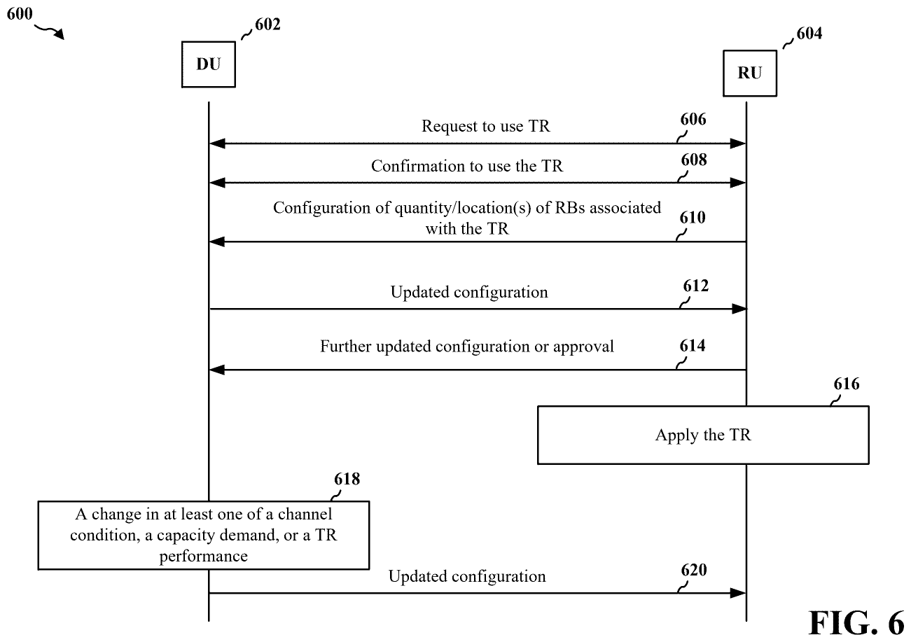

FIG. 6 is a diagram 600 illustrating example communications between a RU 604 and a DU 602, in accordance with various aspects of the present disclosure. For example, the communication between the RU and the DU, e.g., over O-RAN, can improve TR performance. In some aspects, the DU 602 may receive, from the RU 604, a request 606 to use TR. In some aspects, the request 606 to use TR may include a configuration 610 of a quantity of a set of RBs associated with the TR. In some aspects, the configuration 610 may include location(s) of the set of RBs associated with the TR. In some aspects, upon receiving the request 606 to use TR, the DU 602 may respond with a confirmation 608 to use the TR. In some aspects, the confirmation 608 to use the TR may include configuration 612 of quantity or location(s) of RBs associated with the TR that may be determined to be different (or the same) as the quantity or location(s) of RBs provided in the configuration 610. In some aspects, the request 606 to use TR may not include the configuration 610 and the configuration 610 may be transmitted separately after the confirmation 608 from the DU 602. In some aspects, configuration 612 may not be present and the RU may apply the configuration 610 directly (e.g., apply TR at 616 based on the configuration 610 directly). In some aspects, the confirmation 608 to use the TR may not include the configuration 612 and the configuration 612 may be transmitted separately after the configuration 610. In some aspects, the RU 604 may further negotiate with the DU 602 and provide another configuration 614 of quantity or location(s) of RBs associated with the TR, and the negotiation may continue. In some aspects, after the DU 602 finalized or approved the quantity or location(s) of RBs associated with the TR, at 616, the RU 604 may apply the TR based on at least one of the configuration 610, the configuration 612, or the configuration 614. In some aspects, the RU 604 may apply the TR based on more than one of the configuration 610, the configuration 612, or the configuration 614 by partially applying the quantity or subset(s) of location(s) associated with more than one of the configuration 610, the configuration 612, or the configuration 614.

In some aspects, at 618, a change in a channel condition, a capacity demand, or a TR performance may occur, and the DU may transmit a updated configuration 618 to the RU 604 accordingly. In some aspects, the updated configuration 618 may be applied directly by the RU 604. In some aspects, the updated configuration 618 may be further negotiated between the RU 604 and the DU 602.

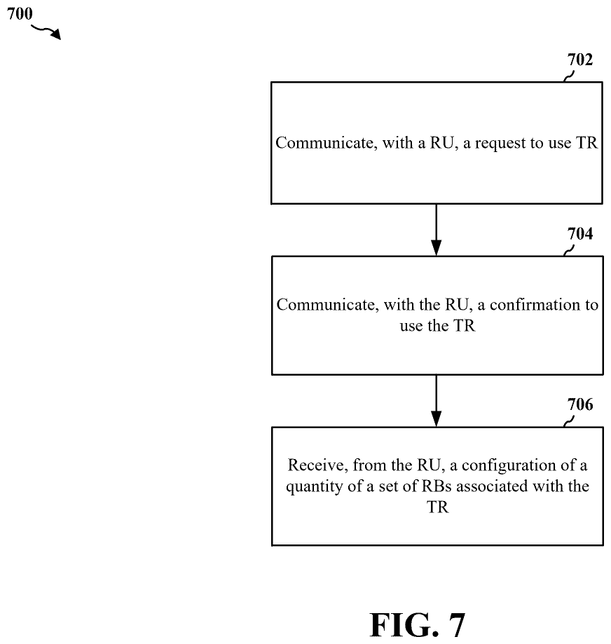

FIG. 7 is a flowchart 700 of a method of wireless communication. The method may be performed by a DU (e.g., the base station 102, the network entity 1102, the network entity 1260). The method may enable a RU and a DU to negotiate usage of TR, such as the quantity of RB(s) that the TR may be applicable to, the location(s) of the RB(s) that the TR may be applicable to, or the like. As an example, the RU and DU may be part of an O-RAN wireless communication system. The method may enable the DU to employ TR as suitable, potentially enabling better control of PAPR and improving overall efficiency of wireless communication.

At 702, the DU may communicate, with a RU, a request to use TR. For example, the DU 602 may communicate with (e.g., receive from or transmit to) a RU 604, a request 606 to use TR. In some aspects, 702 may be performed by TR component 199.

At 704, the DU may communicate, with the RU, a confirmation to use the TR. For example, the DU 602 may communicate with (e.g., receive from or transmit to) the RU 604, a confirmation 608 to use the TR. In some aspects, 704 may be performed by TR component 199.

At 706, the DU may receive, from the RU, a configuration of a quantity of a set of RBs associated with the TR. For example, the DU 602 may receive, from the RU 604, a configuration 610 of a quantity of a set of RBs associated with the TR. In some aspects, 706 may be performed by TR component 199.

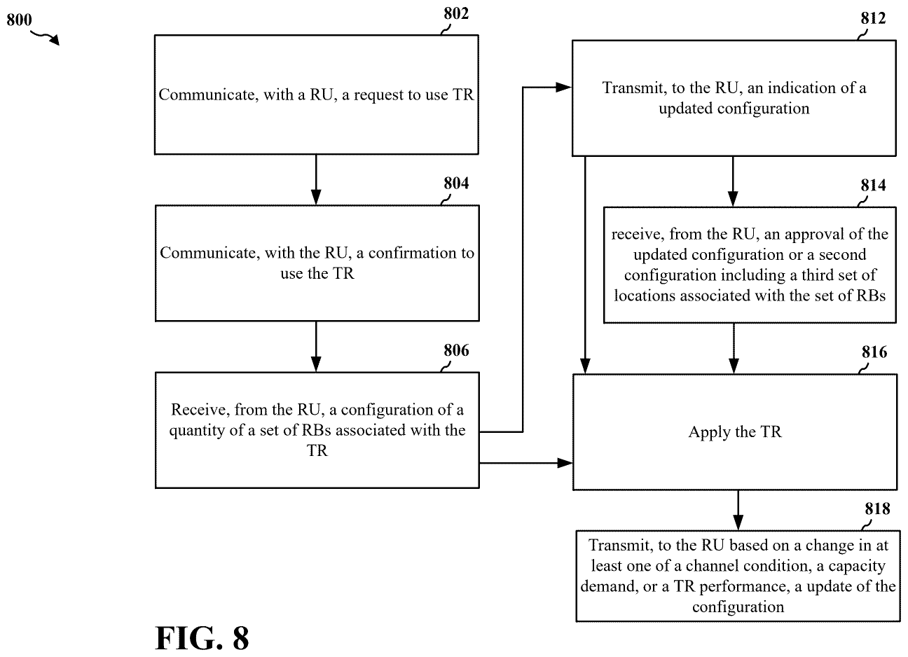

FIG. 8 is a flowchart 800 of a method of wireless communication. The method may be performed by a DU (e.g., as a part of the base station 102, the network entity 1102, the network entity 1260). As an example, the DU may be part of an O-RAN wireless communication system. The method may enable a RU and a DU to negotiate usage of TR, such as the quantity of RB(s) that the TR may be applicable to, the location(s) of the RB(s) that the TR may be applicable to, or the like. The method may enable the DU to employ TR as suitable, potentially enabling better control of PAPR and improving overall efficiency of wireless communication.

At 802, the DU may communicate, with a RU, a request to use TR. For example, the DU 602 may communicate with (e.g., receive from or transmit to) a RU 604, a request 606 to use TR. In some aspects, 802 may be performed by TR component 199.

At 804, the DU may communicate, with the RU, a confirmation to use the TR. For example, the DU 602 may communicate with (e.g., receive from or transmit to) the RU 604, a confirmation 608 to use the TR. In some aspects, 804 may be performed by TR component 199.

At 806, the DU may receive, from the RU, a configuration of a quantity of a set of RBs associated with the TR. For example, the DU 602 may receive, from the RU 604, a configuration 610 of a quantity of a set of RBs associated with the TR. In some aspects, 806 may be performed by TR component 199. In some aspects, the configuration further includes a first set of locations associated with the set of RBs.

At 812, the DU may transmit, to the RU, an indication of a updated configuration. For example, the DU 602 may transmit, to the RU 604, an indication of a updated configuration (e.g., 612). In some aspects, 812 may be performed by TR component 199. In some aspects, the updated configuration includes a second set of locations associated with the set of RBs, and where the second set of locations at least partially overlaps with the first set of locations. In some aspects, the updated configuration includes a second set of locations associated with the set of RBs, and where the second set of locations is different from the first set of locations.

At 814, the DU may receive, from the RU, an approval of the updated configuration or a second configuration including a third set of locations associated with the set of RBs. For example, the DU 602 may receive, from the RU 604, an approval of the updated configuration or a second configuration (e.g., 614) including a third set of locations associated with the set of RBs. In some aspects, 814 may be performed by TR component 199.

At 816, the DU may transmit an approval to apply the TR. For example, the DU 602 may transmit an approval to apply the TR at 616 for the RU 604. In some aspects, 816 may be performed by TR component 199. In some aspects, the DU may apply the TR based on the second set of locations associated with the set of RBs and the quantity of the set of RBs associated with the TR. In some aspects, the DU may apply the TR based on the first set of locations associated with the set of RBs. In some aspects, the DU may apply the TR based on the third set of locations associated with the set of RBs.

In some aspects, the request to use the TR, the confirmation to use the TR, or the configuration includes an indication of waiving at least one RB from the TR. In some aspects, the request to use the TR, the confirmation to use the TR, or the configuration includes an indication of at least one modulation and coding scheme (MCS) associated with the TR, and where the configuration is associated with the at least one MCS. In some aspects, the indication of the at least one MCS includes a set of suggested locations associated with the set of RBs.

At 818, the DU may transmit, to the RU based on a change in at least one of a channel condition, a capacity demand, or a TR performance, a update of the configuration. For example, the DU 602 may transmit, to the RU 604 based on a change in at least one of a channel condition, a capacity demand, or a TR performance, a update (e.g., 620) of the configuration. In some aspects, 818 may be performed by TR component 199. In some aspects, the update of the configuration includes an indication of a reduction of the quantity of the set of RBs associated with the TR based on an increase of the capacity demand. In some aspects, the update of the configuration includes an indication of waiving at least one RB from the TR based on the TR performance associated with the at least one RB.

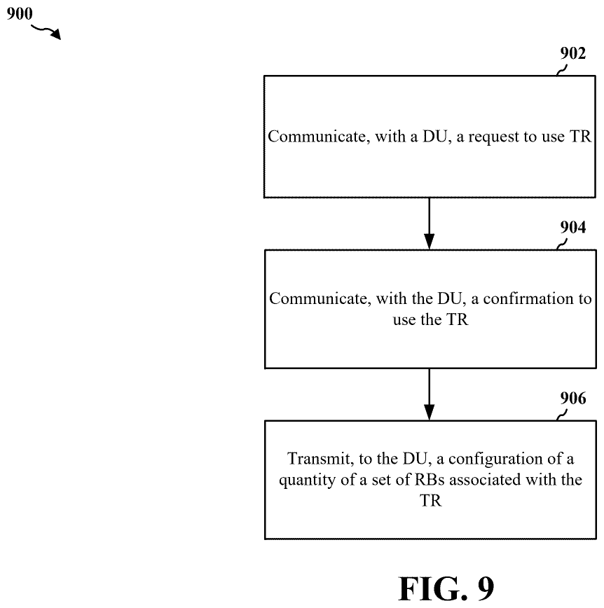

FIG. 9 is a flowchart 900 of a method of wireless communication. The method may be performed by a RU (e.g., as a part of the base station 102, the network entity 1102, the network entity 1260). As an example, the RU may be part of an O-RAN wireless communication system. The method may enable the DU to employ TR as suitable, potentially enabling better control of PAPR and improving overall efficiency of wireless communication.

At 902, the RU may communicate, with a DU, a request to use TR. For example, the RU 604 may communicate with (e.g., receive from or transmit to) a DU 602, a request 606 to use TR. In some aspects, 902 may be performed by TR component 199.

At 904, the RU may communicate, with the DU, a confirmation to use the TR. For example, the RU 604 may communicate with (e.g., receive from or transmit to) the DU 602, a confirmation 608 to use the TR. In some aspects, 904 may be performed by TR component 199.

At 906, the RU may transmit, to the DU, a configuration of a quantity of a set of RBs associated with the TR. For example, the RU 604 may transmit, to the DU 602, a configuration 610 of a quantity of a set of RBs associated with the TR. In some aspects, 906 may be performed by TR component 199.

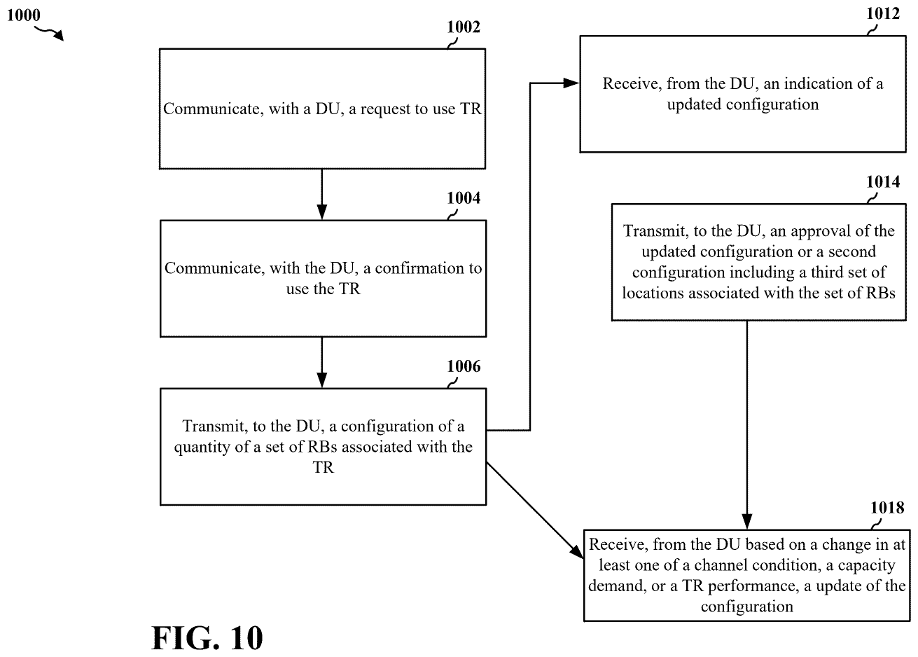

FIG. 10 is a flowchart 1000 of a method of wireless communication. The method may be performed by a RU (e.g., the base station 102, the network entity 1102, the network entity 1260). As an example, the RU may be part of an O-RAN wireless communication system. The method may enable the RU to employ TR as suitable, potentially enabling better control of PAPR and improving overall efficiency of wireless communication.

At 1002, the RU may communicate, with a DU, a request to use TR. For example, the RU 604 may communicate with (e.g., receive from or transmit to) a DU 602, a request 606 to use TR. In some aspects, 1902 may be performed by TR component 199.

At 1004, the RU may communicate, with the DU, a confirmation to use the TR. For example, the RU 604 may communicate with (e.g., receive from or transmit to) the DU 602, a confirmation 608 to use the TR. In some aspects, 1004 may be performed by TR component 199.

At 1006, the RU may transmit, to the DU, a configuration of a quantity of a set of RBs associated with the TR. For example, the RU 604 may transmit, to the DU 602, a configuration 610 of a quantity of a set of RBs associated with the TR. In some aspects, 1006 may be performed by TR component 199. In some aspects, the configuration further includes a first set of locations associated with the set of RBs.

At 1012, the RU may receive, from the DU, an indication of a updated configuration. For example, the RU 604 may receive, from the DU, an indication of a updated configuration (e.g., 612). In some aspects, 1012 may be performed by TR component 199. In some aspects, the updated configuration includes a second set of locations associated with the set of RBs, and where the second set of locations at least partially overlaps with the first set of locations. In some aspects, the updated configuration includes a second set of locations associated with the set of RBs, and where the second set of locations is different from the first set of locations. In some aspects, the RU may apply the updated configuration.

At 1014, the RU may transmit, to the DU, an approval of the updated configuration or a second configuration including a third set of locations associated with the set of RBs. For example, the RU 604 may transmit, to the DU 602, an approval of the updated configuration or a second configuration (e.g., 614) including a third set of locations associated with the set of RBs. In some aspects, 1014 may be performed by TR component 199. In some aspects, the RU may apply the TR based on the updated configuration or the second configuration.

In some aspects, the request to use the TR or the confirmation to use the TR includes an indication of waiving at least one RB from the TR. In some aspects, the request to use the TR or the confirmation to use the TR includes an indication of at least one modulation and coding scheme (MCS) associated with the TR, and where the configuration is associated with the at least one MCS. In some aspects, the indication of the at least one MCS includes a set of suggested locations associated with the set of RBs.

At 1018, the RU may receive, from the DU based on a change in at least one of a channel condition, a capacity demand, or a TR performance, a update of the configuration. For example, the RU 604 may receive, from the DU 602 based on a change in at least one of a channel condition, a capacity demand, or a TR performance, a update of the configuration (e.g., 620). In some aspects, 1018 may be performed by TR component 199. In some aspects, the update of the configuration includes an indication of a reduction of the quantity of the set of RBs associated with the TR based on an increase of the capacity demand. In some aspects, the update of the configuration includes an indication of waiving at least one RB from the TR based on the TR performance associated with the at least one RB.

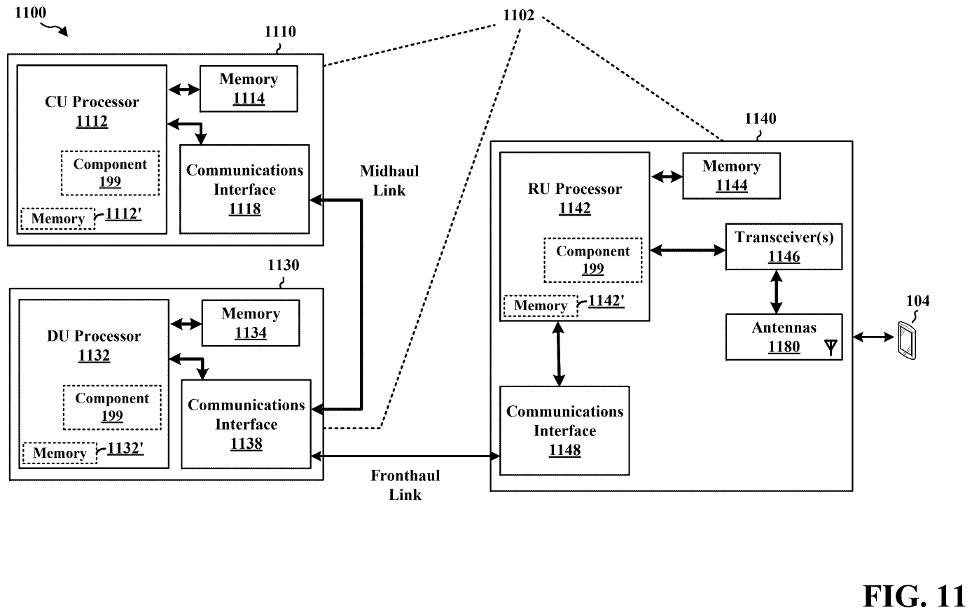

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the TR component 199 may be configured to communicate, with a RU, a request to use TR. In some aspects, the TR component 199 may be further configured to communicate, with the RU, a confirmation to use the TR. In some aspects, the TR component 199 may be further configured to receive, from the RU, a configuration of a quantity of a set of RBs associated with the TR. In some aspects, the TR component 199 may be configured to communicate, with a DU, a request to use TR. In some aspects, the TR component 199 may be further configured to communicate, with the DU, a confirmation to use the TR. In some aspects, the TR component 199 may be further configured to transmit, to the DU, a configuration of a quantity of a set of RBs associated with the TR.

The TR component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In some aspects, the network entity 1102 may include means for receiving, from a RU, a request to use TR. In some aspects, the network entity 1102 may include means for communicating, with the RU, a confirmation to use the TR. In some aspects, the network entity 1102 may include means for communicating, with the RU, a configuration of a quantity of a set of RBs associated with the TR. In some aspects, the network entity 1102 may include means for transmitting, to the RU, an indication of a updated configuration, where the updated configuration includes a second set of locations associated with the set of RBs, and where the second set of locations at least partially overlaps with the first set of locations. In some aspects, the network entity 1102 may include means for applying the TR based on the second set of locations associated with the set of RBs and the quantity of the set of RBs associated with the TR. In some aspects, the network entity 1102 may include means for transmitting, to the RU, an indication of a updated configuration, where the updated configuration includes a second set of locations associated with the set of RBs, and where the second set of locations is different from the first set of locations. In some aspects, the network entity 1102 may include means for receiving, from the RU, an approval of the updated configuration or a second configuration including a third set of locations associated with the set of RBs. In some aspects, the network entity 1102 may include means for transmitting, to the RU based on a change in at least one of a channel condition, a capacity demand, or a TR performance, a update of the configuration. In some aspects, the network entity 1102 may include means for transmitting, to a DU, a request to use TR. In some aspects, the network entity 1102 may include means for receiving, from the DU, a confirmation to use the TR. In some aspects, the network entity 1102 may include means for transmitting, to the DU, a configuration of a quantity of a set of RBs associated with the TR. In some aspects, the network entity 1102 may include means for receiving, from the DU, an indication of a updated configuration, where the updated configuration includes a second set of locations associated with the set of RBs, and where the second set of locations at least partially overlaps with the first set of locations. In some aspects, the network entity 1102 may include means for receiving, from the DU, an indication of a updated configuration, where the updated configuration includes a second set of locations associated with the set of RBs, and where the second set of locations is different from the first set of locations. In some aspects, the network entity 1102 may include means for transmitting, to the DU, an approval of the updated configuration or a second configuration including a third set of locations associated with the set of RBs. In some aspects, the network entity 1102 may include means for receiving, from the DU based on a change in at least one of a channel condition, a capacity demand, or a TR performance, a update of the configuration. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

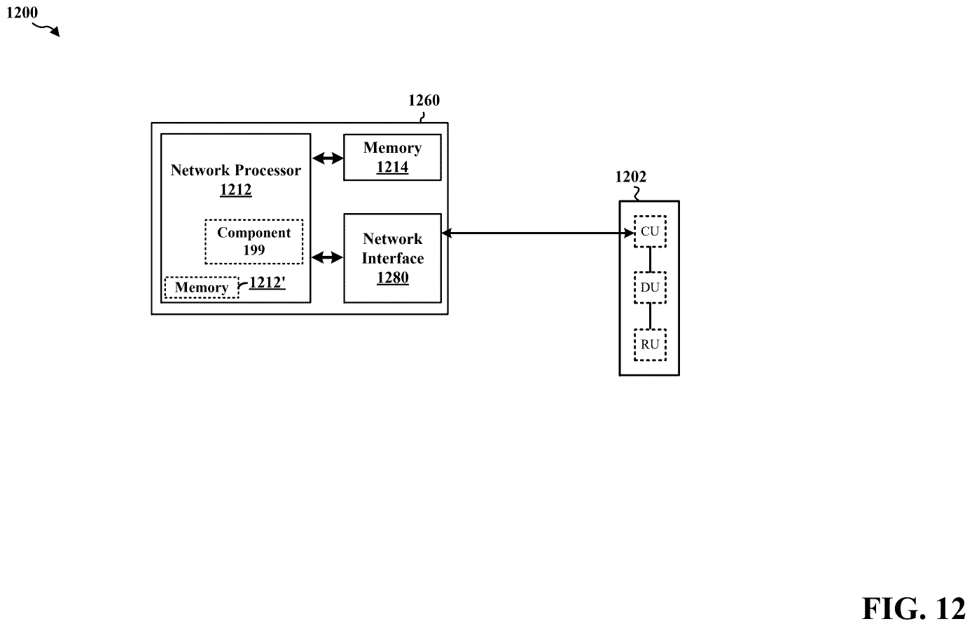

FIG. 12 is a diagram 1200 illustrating an example of a hardware implementation for a network entity 1260. In one example, the network entity 1260 may be within the core network 120. The network entity 1260 may include at least one network processor 1212. The network processor(s) 1212 may include on-chip memory 1212′. In some aspects, the network entity 1260 may further include additional memory modules 1214. The network entity 1260 communicates via the network interface 1280 directly (e.g., backhaul link) or indirectly (e.g., through a RIC) with the CU 1202. The on-chip memory 1212′ and the additional memory modules 1214 may each be considered a computer-readable medium/memory. Each computer-readable medium/memory may be non-transitory. The network processor(s) 1212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the TR component 199 may be configured to communicate, with a RU, a request to use TR. In some aspects, the TR component 199 may be further configured to transmit, to the RU, a confirmation to use the TR. In some aspects, the TR component 199 may be further configured to communicate, with the RU, a configuration of a quantity of a set of RBs associated with the TR. In some aspects, the TR component 199 may be configured to transmit, to a DU, a request to use TR. In some aspects, the TR component 199 may be further configured to receive, from the DU, a confirmation to use the TR. In some aspects, the TR component 199 may be further configured to transmit, to the DU, a configuration of a quantity of a set of RBs associated with the TR.

The component 199 may be within the network processor(s) 1212. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1260 may include a variety of components configured for various functions. In some aspects, the network entity 1260 may include means for communicating, with a RU, a request to use TR. In some aspects, the network entity 1260 may include means for communicating, with the RU, a confirmation to use the TR. In some aspects, the network entity 1260 may include means for receiving, from the RU, a configuration of a quantity of a set of RBs associated with the TR. In some aspects, the network entity 1260 may include means for transmitting, to the RU, an indication of a updated configuration, where the updated configuration includes a second set of locations associated with the set of RBs, and where the second set of locations at least partially overlaps with the first set of locations. In some aspects, the network entity 1260 may include means for applying the TR based on the second set of locations associated with the set of RBs and the quantity of the set of RBs associated with the TR. In some aspects, the network entity 1260 may include means for transmitting, to the RU, an indication of a updated configuration, where the updated configuration includes a second set of locations associated with the set of RBs, and where the second set of locations is different from the first set of locations. In some aspects, the network entity 1260 may include means for receiving, from the RU, an approval of the updated configuration or a second configuration including a third set of locations associated with the set of RBs. In some aspects, the network entity 1260 may include means for transmitting, to the RU based on a change in at least one of a channel condition, a capacity demand, or a TR performance, a update of the configuration. In some aspects, the network entity 1260 may include means for transmitting, to a DU, a request to use TR. In some aspects, the network entity 1260 may include means for receiving, from the DU, a confirmation to use the TR. In some aspects, the network entity 1260 may include means for transmitting, to the DU, a configuration of a quantity of a set of RBs associated with the TR. In some aspects, the network entity 1260 may include means for receiving, from the DU, an indication of a updated configuration, where the updated configuration includes a second set of locations associated with the set of RBs, and where the second set of locations at least partially overlaps with the first set of locations. In some aspects, the network entity 1260 may include means for receiving, from the DU, an indication of a updated configuration, where the updated configuration includes a second set of locations associated with the set of RBs, and where the second set of locations is different from the first set of locations. In some aspects, the network entity 1260 may include means for transmitting, to the DU, an approval of the updated configuration or a second configuration including a third set of locations associated with the set of RBs. In some aspects, the network entity 1260 may include means for receiving, from the DU based on a change in at least one of a channel condition, a capacity demand, or a TR performance, a update of the configuration. The means may be the component 199 of the network entity 1260 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a distributed unit (DU), including: at least one memory; and at least one processor coupled to the at least one memory, and based at least in part on information stored in the at least one memory, the at least one processor is configured to: communicate, with a radio unit (RU), a request to use tone reservation (TR); communicate, with the RU, a confirmation to use the TR; and receive, from the RU, a configuration of a quantity of a set of resource blocks (RBs) associated with the TR.

Aspect 2 is the apparatus of aspect 1, where the configuration further includes a first set of locations associated with the set of RBs.

Aspect 3 is the apparatus of aspect 2, where the at least one processor is further configured to: transmit, to the RU, an indication of a updated configuration, where the updated configuration includes a second set of locations associated with the set of RBs, and where the second set of locations at least partially overlaps with the first set of locations; and transmit an approval to apply the TR based on the second set of locations associated with the set of RBs and the quantity of the set of RBs associated with the TR.

Aspect 4 is the apparatus of any of aspects 2-3, where the at least one processor is further configured to: transmit, to the RU, an indication of a updated configuration, where the updated configuration includes a second set of locations associated with the set of RBs, and where the second set of locations is different from the first set of locations; and receive, from the RU, an approval of the updated configuration or a second configuration including a third set of locations associated with the set of RBs.

Aspect 5 is the apparatus of any of aspects 2-4, where the request to use the TR or the confirmation to use the TR includes an indication of waiving at least one RB from the TR.

Aspect 6 is the apparatus of any of aspects 1-5, where to communicate the request to use the TR, the at least one processor is configured to receive, from the RU, the request to use the TR; and where to communicate the confirmation to use the TR, the at least one processor is configured to transmit, to the RU, the confirmation to use the TR.

Aspect 7 is the apparatus of any of aspects 1-5, where to communicate the request to use the TR, the at least one processor is configured to transmit, to the RU, the request to use the TR; and where to communicate the confirmation to use the TR, the at least one processor is configured to receive, from the RU, the confirmation to use the TR.

Aspect 8 is the apparatus of any of aspects 1-7, where the at least one processor is further configured to: transmit, to the RU based on a change in at least one of a channel condition, a capacity demand, or a TR performance, a update of the configuration.

Aspect 9 is the apparatus of aspect 8, where the update of the configuration includes an indication of a reduction of the quantity of the set of RBs associated with the TR based on an increase of the capacity demand.

Aspect 10 is the apparatus of any of aspects 8-9, where the update of the configuration includes an indication of waiving at least one RB from the TR based on the TR performance associated with the at least one RB.

Aspect 11 is an apparatus for wireless communication at a radio unit (RU), including: at least one memory; and at least one processor coupled to the at least one memory, and based at least in part on information stored in the at least one memory, the at least one processor is configured to: communicate, with a distributed unit (DU), a request to use tone reservation (TR); communicate, with the DU, a confirmation to use the TR; and transmit, to the DU, a configuration of a quantity of a set of resource blocks (RBs) associated with the TR.

Aspect 12 is the apparatus of aspect 11, where the configuration further includes a first set of locations associated with the set of RBs.

Aspect 13 is the apparatus of aspect 12, where the at least one processor is further configured to: receive, from the DU, an indication of a updated configuration, where the updated configuration includes a second set of locations associated with the set of RBs, and where the second set of locations at least partially overlaps with the first set of locations; and apply the TR based on the second set of locations associated with the set of RBs and the quantity of the set of RBs associated with the TR.

Aspect 14 is the apparatus of any of aspects 12-13, where the at least one processor is further configured to: receive, from the DU, an indication of a updated configuration, where the updated configuration includes a second set of locations associated with the set of RBs, and where the second set of locations is different from the first set of locations; and transmit, to the DU, an approval of the updated configuration or a second configuration including a third set of locations associated with the set of RBs.

Aspect 15 is the apparatus of any of aspects 12-14, where the request to use the TR or the confirmation to use the TR includes an indication of waiving at least one RB from the TR.

Aspect 16 is the apparatus of any of aspects 11-15, where to communicate the request to use the TR, the at least one processor is configured to transmit, to the DU, the request to use the TR; and where to communicate the confirmation to use the TR, the at least one processor is configured to receive, from the RU, the confirmation to use the TR.

Aspect 17 is the apparatus of any of aspects 11-15, where to communicate the request to use the TR, the at least one processor is configured to receive, from the DU, the request to use the TR; and where to communicate the confirmation to use the TR, the at least one processor is configured to transmit, to the DU, the confirmation to use the TR.

Aspect 18 is the apparatus of any of aspects 12-17, where the at least one processor is further configured to: receive, from the DU based on a change in at least one of a channel condition, a capacity demand, or a TR performance, a update of the configuration.

Aspect 19 is the apparatus of aspect 18, where the update of the configuration includes an indication of a reduction of the quantity of the set of RBs associated with the TR based on an increase of the capacity demand.

Aspect 20 is the apparatus of any of aspects 18-19, where the update of the configuration includes an indication of waiving at least one RB from the TR based on the TR performance associated with the at least one RB.

Aspect 21 is a method of wireless communication for implementing any of aspects 1 to 20.

Aspect 22 is a computer-readable medium (e.g., a non-transitory computer-readable medium) storing computer executable code, the code when executed by at least one processor causes the at least one processor to implement any of aspects 1 to 20.

Aspect 23 is an apparatus comprising means for implementing any of aspects 1 to 20.

What is claimed is:

1. An apparatus for wireless communication at a distributed unit (DU), comprising:
at least one memory; and
at least one processor coupled to the at least one memory, and based at least in part on information stored in the at least one memory, the at least one processor is configured to:
communicate, with a radio unit (RU), a request to use tone reservation (TR);
communicate, with the RU, a confirmation to use the TR; and
receive, from the RU, a configuration of a quantity of a set of resource blocks (RBs) associated with the TR.

2. The apparatus of claim 1, wherein the configuration further comprises a first set of locations associated with the set of RBs.

3. The apparatus of claim 2, wherein the at least one processor is further configured to:
transmit, to the RU, an indication of a updated configuration, wherein the updated configuration comprises a second set of locations associated with the set of RBs, and wherein the second set of locations at least partially overlaps with the first set of locations; and
transmit an approval to apply the TR based on the second set of locations associated with the set of RBs and the quantity of the set of RBs associated with the TR.

4. The apparatus of claim 2, wherein the at least one processor is further configured to:
transmit, to the RU, an indication of a updated configuration, wherein the updated configuration comprises a second set of locations associated with the set of RBs, and wherein the second set of locations is different from the first set of locations; and
receive, from the RU, an approval of the updated configuration or a second configuration comprising a third set of locations associated with the set of RBs.

5. The apparatus of claim 2, wherein the request to use the TR or the confirmation to use the TR comprises an indication of waiving at least one RB from the TR.

6. The apparatus of claim 1, wherein to communicate the request to use the TR, the at least one processor is configured to receive, from the RU, the request to use the TR;
and wherein to communicate the confirmation to use the TR, the at least one processor is configured to transmit, to the RU, the confirmation to use the TR.

7. The apparatus of claim 1, wherein to communicate the request to use the TR, the at least one processor is configured to transmit, to the RU, the request to use the TR; and wherein to communicate the confirmation to use the TR, the at least one processor is configured to receive, from the RU, the confirmation to use the TR.

8. The apparatus of claim 1, wherein the at least one processor is further configured to:
transmit, to the RU based on a change in at least one of a channel condition, a capacity demand, or a TR performance, a update of the configuration.

9. The apparatus of claim 8, wherein the update of the configuration comprises an indication of a reduction of the quantity of the set of RBs associated with the TR based on an increase of the capacity demand.

10. The apparatus of claim 8, wherein the update of the configuration comprises an indication of waiving at least one RB from the TR based on the TR performance associated with the at least one RB.

11. An apparatus for wireless communication at a radio unit (RU), comprising:
at least one memory; and
at least one processor coupled to the at least one memory, and based at least in part on information stored in the at least one memory, the at least one processor is configured to:
communicate, with a distributed unit (DU), a request to use tone reservation (TR);
communicate, with the DU, a confirmation to use the TR; and
transmit, to the DU, a configuration of a quantity of a set of resource blocks (RBs) associated with the TR.

12. The apparatus of claim 11, wherein the configuration further comprises a first set of locations associated with the set of RBs.

13. The apparatus of claim 12, wherein the at least one processor is further configured to:
receive, from the DU, an indication of a updated configuration, wherein the updated configuration comprises a second set of locations associated with the set of RBs, and wherein the second set of locations at least partially overlaps with the first set of locations; and
apply the TR based on the second set of locations associated with the set of RBs and the quantity of the set of RBs associated with the TR.

14. The apparatus of claim 12, wherein the at least one processor is further configured to:
receive, from the DU, an indication of a updated configuration, wherein the updated configuration comprises a second set of locations associated with the set of RBs, and wherein the second set of locations is different from the first set of locations; and
transmit, to the DU, an approval of the updated configuration or a second configuration comprising a third set of locations associated with the set of RBs.

15. The apparatus of claim 12, wherein the request to use the TR or the confirmation to use the TR comprises an indication of waiving at least one RB from the TR.

16. The apparatus of claim 11, wherein to communicate the request to use the TR, the at least one processor is configured to transmit, to the DU, the request to use the TR; and
wherein to communicate the confirmation to use the TR, the at least one processor is configured to receive, from the RU, the confirmation to use the TR.

17. The apparatus of claim 11, wherein to communicate the request to use the TR, the at least one processor is configured to receive, from the DU, the request to use the TR; and wherein to communicate the confirmation to use the TR, the at least one processor is configured to transmit, to the DU, the confirmation to use the TR.

18. The apparatus of claim 11, wherein the at least one processor is further configured to:
receive, from the DU based on a change in at least one of a channel condition, a capacity demand, or a TR performance, a update of the configuration.

19. The apparatus of claim 18, wherein the update of the configuration comprises an indication of a reduction of the quantity of the set of RBs associated with the TR based on an increase of the capacity demand.

20. The apparatus of claim 18, wherein the update of the configuration comprises an indication of waiving at least one RB from the TR based on the TR performance associated with the at least one RB.
